(19) United States
(12) Patent Application Publication
(10) Pub. No.: US 2009/0180869 A1
(43) Pub. Date: Jul. 16, 2009

(54) Inlet wind suppressor assembly

(76) Inventor: Gerald E. Brock, Livonia, NY (US)

Correspondence Address: Woods Oviatt Gilman LLP, 700 Crossroads Bldg, 2 State St., Rochester, NY, 14614, US

(21) Appl. No.: 12/009,057

(22) Filed: Jan. 16, 2008

(51) Int. Cl. F04D 29/54; F03D 11/00; F01D 5/22

(52) U.S. Cl. 415/208.2; 416/179

(57) ABSTRACT

A diffuser augmented wind turbine assembly comprising an inlet wind suppressor and a shroud disposed within said inlet wind suppressor. The assembly contains a wind turbine; the wind turbine is disposed within the shroud; and the shroud is connected to a diffuser.

### FIELD OF THE INVENTION

A diffuser augmented wind turbine assembly comprising an inlet wind suppressor connected to the inlet port of a diffuser augmented wind turbine assembly.

### BACKGROUND OF THE INVENTION

U.S. Pat. No. 7,218,011, the entire disclosure of which is hereby incorporated by reference into this specification, discloses and claims a diffuser augmented wind turbine assembly. Claim 1 of this patent describes “1. A diffuser-augmented wind-turbine assembly, the assembly having a diffuser outer-housing shell with an inner cylindrical portion, a rotor drum having inner and outer surfaces, the inner surface rigidly supporting a plurality of turbine blades, and bearing means positioned between the diffuser-shell inner cylindrical portion and the rotor-drum outer surface for rotatably supporting the rotor drum, the rotor drum being in driving engagement with a rotatable electrical generator.”

Another diffuser augmented wind turbine assembly is disclosed in U.S. Pat. No. 4,075,500, the entire disclosure of which is also hereby incorporated by reference into this specification. Claim 1 of this patent describes: “1. What is claimed is: 1. A wind turbine comprising: a rotatable duct having an outlet to inlet area ratio greater than one; a wind-rotatable turbine mounted within said duct; a generator driven by said turbine, said generator being a synchronous generator loading the drive from the turbine; and stator means to vary the incidence of wind for rotating the turbine wherein the stator means includes a fixed leading portion and a trailing edge flap that is movable relative to the fixed leading portion, said trailing edge flap being movable by means sensitive to wind velocity to vary the swirl imparted to flow thereby providing a good working load distribution to all radial, span, stations of the turbine in optimizing disk loading for the turbine and the duct thereabout, so that with the load on the drive by the generator, constant turbine speed control can be effectuated over a wide range of wind velocities.”

The diffuser augmented wind turbine assemblies described in such United States patents are not very efficient. It is an object of this invention to provide an improved diffuser augmented wind turbine assembly that is more efficient than the prior art diffuser augmented wind turbine assemblies.

### SUMMARY OF THE INVENTION

In accordance with this invention, there is provided a diffuser augmented wind turbine assembly comprising an inlet wind suppressor connected to the inlet port of a diffuser augmented wind turbine assembly.

### BRIEF DESCRIPTION OF THE DRAWINGS

The invention will be described by reference to the specification and the enclosed drawings, wherein like numerals refer to like elements, and wherein:

FIG. 1 is a perspective view of one preferred diffuser augmented wind turbine assembly;

FIG. 2 is an exploded perspective view of the preferred assembly of FIG. 1;

FIG. 3 is a perspective view of preferred housing used in the apparatus depicted in FIG. 1;

FIG. 4 is a perspective view of a wind turbine assembly;

FIG. 5 is an exploded perspective view of the wind turbine assembly depicted in FIG. 4;

FIG. 6 is a sectional side view of assembly 10;

FIG. 7 is a side sectional view of the wind turbine assembly depicted in FIG. 4;

FIG. 8 is a side schematic view of a rotor blade tip vorticity reducer;

FIG. 9 is a perspective front view of the vorticity reducer depicted in FIG. 8;

FIG. 10 is a perspective view of a wind suppressor inlet assembly; and

FIG. 11 is a front view of the suppressor inlet assembly depicted in FIG. 10.

### DESCRIPTION OF THE PREFERRED EMBODIMENTS

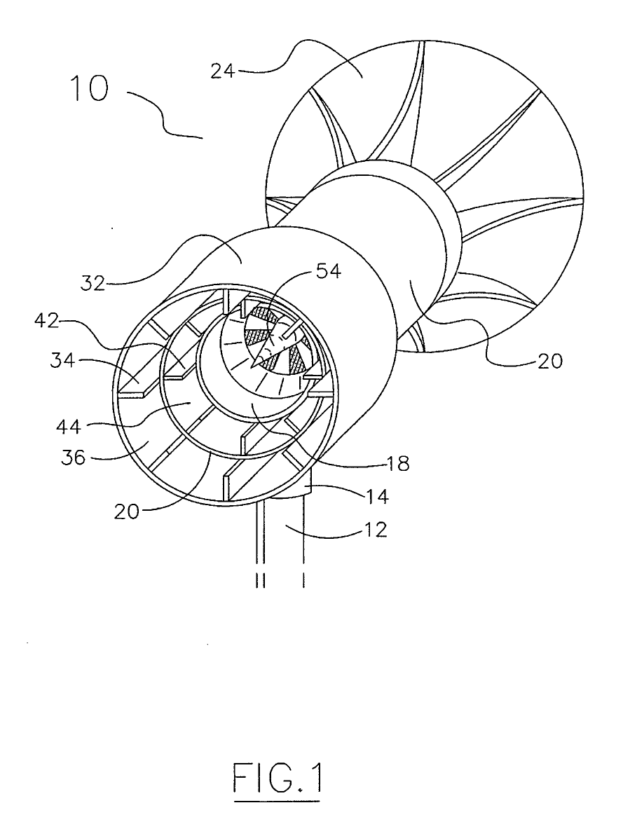

FIG. 1 is a schematic view of a preferred diffuser augmented wind turbine assembly 10 that, in the preferred embodiment depicted, is mounted on a support 12. The support 12 may be connected, e.g., to a fixed structure (such as the ground, a building, a carriage assembly) and/or to movable structure. In one preferred embodiment, the support 12 is rotatably connected to assembly 10 so that the assembly 10 can rotate (or be rotated). In another embodiment, the support 12 is fixedly connected to assembly 10.

In one embodiment, not shown, a yaw motor is operatively connected to the assembly 10 to rotate it.

In one embodiment, the support structure depicted in U.S. Pat. No. 4,075,500 by reference to elements 24, 26, and 28 may be used. At column 4 of this patent, e.g., it disclosed that “The duct or shroud 18 is mounted by a mast 24 to a rotatable joint 26 on a tower 28 so as to be selfcocking into the direction of the wind.” Such an assembly could be used in connection with device 10.

In another embodiment, the support structure depicted U.S. Pat. No. 7,218,011 by elements 11 and 12 may be utilized. As is disclosed in column 1 of such patent, “FIG. 1 shows a diffuser augmented wind-turbine assembly 10 rotatably mounted on a conventional support pole 11 so that it can be moved by a find 12 to compensate for shifting wind directions.

Referring again to FIG. 1, and to the preferred embodiment depicted therein, it will be seen that support 12 is disposed within sleeve 14. In one embodiment, bearings (not shown) are disposed within sleeve 14 to facilitate the rotation of support 12 within such sleeve 14.

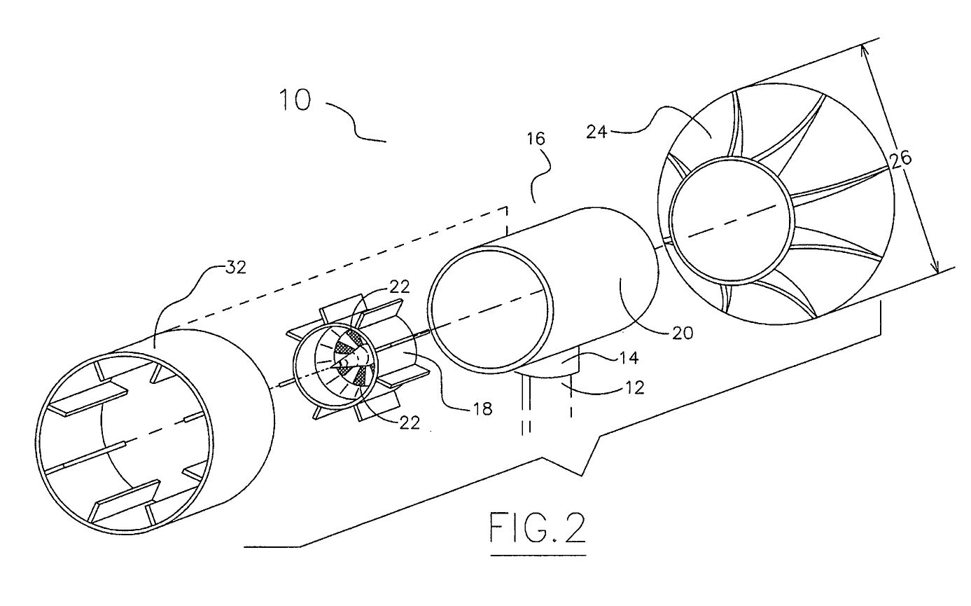

FIG. 2 illustrates that, in one preferred embodiment, sleeve 14 is connected to a wind turbine assembly 16 comprised of a wind turbine 18 disposed within a housing 20.

One may use any of the wind turbine assemblies 16 known to those skilled in the art. Thus, e.g., and by way of illustration and not limitation, one may use the wind turbine assemblies disclosed in U.S. Pat. Nos. 4,021,135 (wind turbine), 4,075,500 (variable stator diffuser augmented wind turbine electrical generation system), 4,218,175 (wind turbine), 4,285,481 (multiple wind turbine tethered airfoil wind energy conversion system), 4,324,985 (portable wind turbine for charging batteries), 4,482,290 (diffuser for augmenting a wind turbine), 4,684,316 (improvements in wind turbine having a wing-profiled diffuser), 4,915,580 (wind turbine runner impulse type), 6,493,743 Let assisted hybrid wind turbine system), 6,638,005 (coaxial wind turbine apparatus having a closeable air inlet opening), 7,218,011 (diffuser augmented wind turbine), 7,230,348 (infuser augmented wind turbine electrical generating system), and the like. The entire disclosure of each of these United States patents is hereby incorporated by reference into this specification.

In one embodiment, one may use one or more of the wind turbine assemblies disclosed in applicant's U.S. Pat. No. 6,655,907, the entire disclosure of which is hereby incorporated by reference into this specification. Claim 1 of this patent describes: “1. A fluid-driven power generator comprised of a turbine comprised of a multiplicity of vanes, wherein said turbine is within a housing assembly, and wherein said housing assembly is comprised of an exhaust chamber, means for directing a first fluid towards said vanes of said turbine, means for directing a second fluid through said housing assembly without contacting said turbine, means for combining said first fluid and said second fluid in said exhaust chamber, and means for creating a vacuum in said exhaust chamber, wherein: (a) said means for directing fluid towards said tangential portions of said turbine comprises a first interior sidewall, and a second interior sidewall connected to said first sidewall, and (b) said means for directing fluid towards said tangential portions of said turbine is comprised of means for causing said fluid to flow around said turbine and, for at least about 120 degrees of said flow of said fluid around said turbine, for constricting said fluid and increasing its pressure.”

In one embodiment, the turbine 16 is an axial flow wind turbine. These wind turbines are well known and are described, e.g., in the claims of U.S. Pat. No. 6,223,558, the entire disclosure of which is hereby incorporated by reference into this specification.

The preferred axial flow wind turbine 16 is comprised of a multiplicity of wind turbine blades 22 disposed within housing/shroud. These turbine blades are well known to those skilled in the art. Reference may be had, e.g., to U.S. Pat. Nos. 3,425,665 (gas turbine rotor blade shroud), 3,656,863 (transpiration cooled turbine rotor blade), 3,902,820 (fluid cooled turbine rotor blade), 4,066,384 (turbine rotor blade having integral tenon thereon and split shroud ring associated therewith), 4,424,002 (tip structure for cooled turbine rotor blade), 4,480,956 (turbine rotor blade for a turbomachine), 4,056,639 (axial flow turbine blade), 4,784,569 (shroud means for turbine rotor blade tip clearance control), 4,976,587 (composite wind turbine rotor blade), 5,059,095 (turbine rotor blade coated with alumina-zirconia cramic), 5,474,425 (wind turbine rotor blade), 5,660,527 (wind turbine rotor blade root end), 6,877,955 (mixed flow turbine rotor blade), 6,966,758 (wind turbine rotor blade comprising one or more means secured to the blade for changing the profile thereof depending on the atmospheric temperature), 7,063,508 (turbine rotor blade), and the like. The entire disclosure of each of these United States patents is hereby incorporated by reference into this specification.

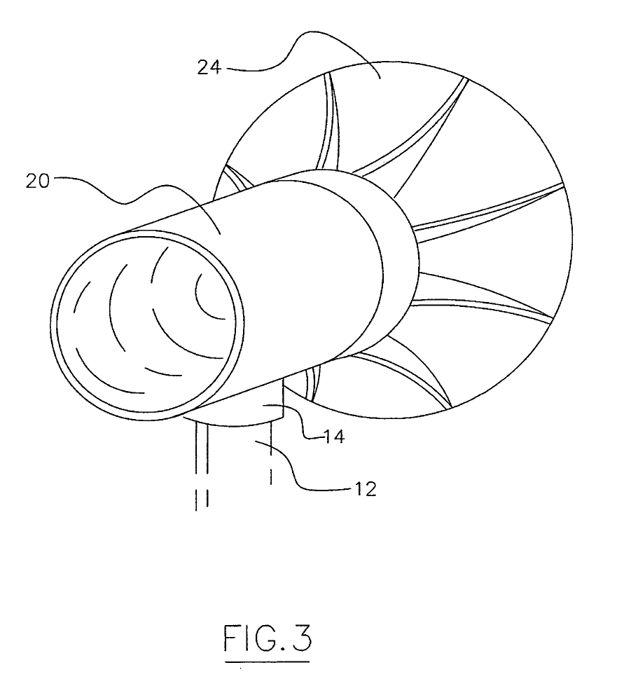

Referring again to FIGS. 1 and 3, it will be seen that, in the embodiment depicted, shroud 20 is connected to a diffuser 24. The diffuser 24 in the embodiment depicted, has a maximum cross-sectional dimension 26 that is substantially larger than the diameter of shroud 20. These (and other) diffusers are well known and are described, e.g., in U.S. Pat. Nos. 3,364,678 (turbine radial diffuser), 3,978,664 (gas turbine engine diffuser), 4,075,500 (variable stator, diffuser augmented wind turbine electrical generation system), 4,177,638 (single shaft gas turbine engine with radial exhaust diffuser), 4,422,820 (spoiler for fluid turbine diffuser), 4,458,479 (diffuser for gas turbine engine), 4,482,290 (diffuser for augmenting a wind turbine), 4,503,668 (strutless diffuser for a gas turbine engine), 4,527,386 (diffuser for gas turbine engine), 5,462,088 (gas turbine exhaust diffuser), 5,704,211 (gas turbine engine with radial diffuser), 6,488,470 (annular flow diffusers for gas turbines), 6,866,479 (exhaust diffuser for axial flow turbine), 7,114,255 (method of making a gas turbine engine diffuser), 7,218,011 (diffuser augmented wind turbine), and the like. The entire disclosure of each of these United States is hereby incorporated by reference into this specification.

As will be apparent, the combination of the wind turbine assembly 16 (comprised of the shroud 20 and its associated structure) and the diffuser 24 comprises a diffuser augmented wind turbine assembly.

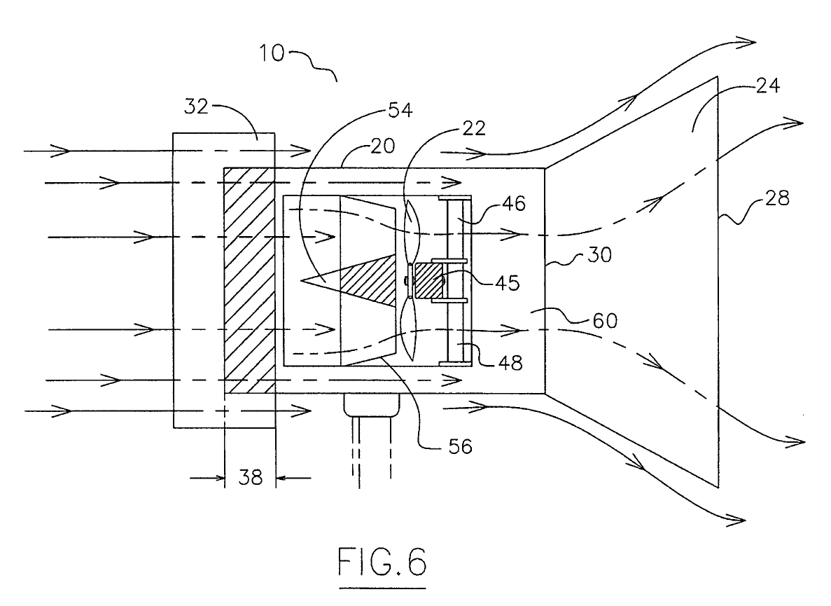

FIG. 6 is a plan sectional viewing better illustrating the relationship between diffuser 24 and shroud 20. In the preferred embodiment depicted, it will be seen that the maximum dimension 26 of the diffuser 24 occurs at its outlet 28, and that such maximum dimension 24 is greater than the maximum dimension of shroud 20 occurs, in the embodiment depicted, at the outlet 30 of such shroud. The dimension 24 is at least about 1.5 times as great as maximum dimension of the shroud and, and, preferably, is at least 2.0 times as great as such maximum dimension. In one embodiment, the dimension 24 is at least about 2.5 times as great as the maximum dimension of the shroud.

Referring again to FIG. 6, and to the preferred embodiment depicted therein, it will be seen that shroud 20 is partially disposed within wind inlet suppressor 32.

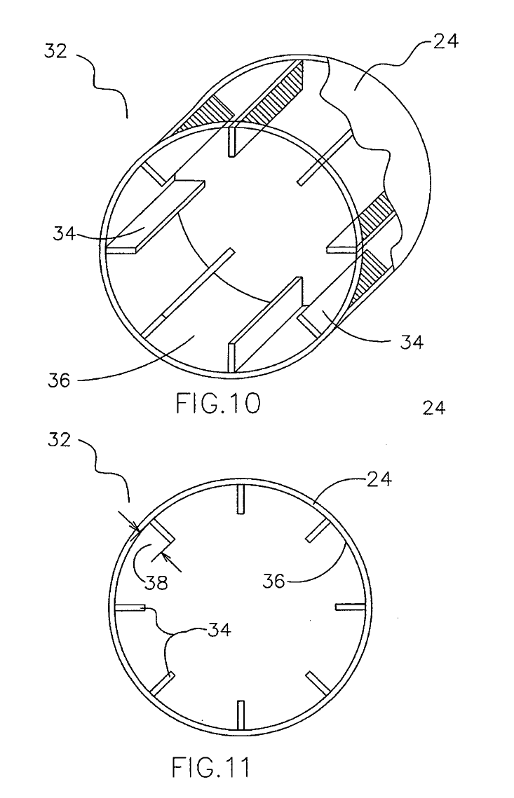

FIG. 10 is a sectional perspective view of a wind inlet suppressor assembly 32, and FIG. 11 is a front view of suppressor assembly 32. In the embodiment, depicted, suppressor assembly 32 is comprised of a multiplicity of vanes 34.

The vanes 34, in one embodiment, are integrally joined to the interior surface 36 of the wind inlet suppressor assembly 32. In one embodiment, each of such vanes is substantially perpendicular to such interior surface 36.

In the embodiment, each of the vanes 34 has a length 38 that is from 2 to about 20 percent of the total internal diameter of the suppressor. As will be seen from the embodiment depicted in, e.g., FIG. 1, the vanes extend from interior surface 36 until they are substantially contiguous with the shroud 20.

Referring again to FIGS. 10 and 11, it will be seen that vanes 34 are disposed substantially equidistantly around the interior surface 36.

Referring again to FIG. 1, and to the preferred embodiment depicted therein, it will be seen that shroud 20 is within the suppressor assembly 32. This is also shown, e.g., in FIG. 2.

Referring to FIG. 6, and to the preferred embodiment depicted therein, it will be seen that shroud 20 is only partially disposed within the suppressor assembly 32. In the embodiment depicted in FIG. 6, the shroud 20 extends within the suppressor assembly 32 a distance 38 that often is from about 6 inches to about 1 foot. As will be apparent, the distance 38 varies depending upon the dimensions of the components of the overall assembly.

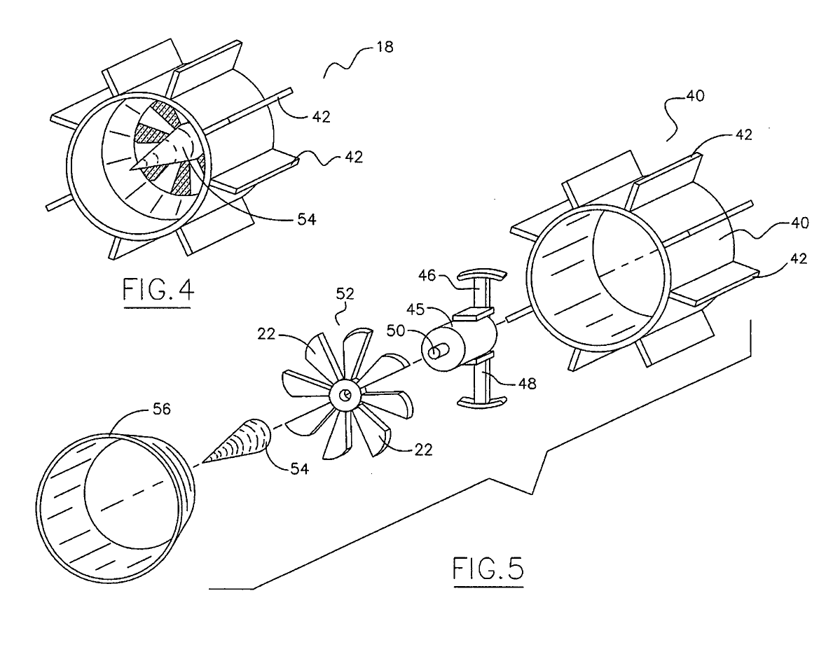

FIG. 2 is an exploded view of assembly 10 illustrating how shroud 20 is disposed within assembly 32, and how turbine assembly 18 is disposed within shroud 20. The wind turbine assembly 18 is illustrated in greater detail in FIGS. 4 and 5.

Referring to such Figures, it will be seen that assembly 18 is comprised of housing 40. Such housing 40 is comprised of a multiplicity of vanes 42 that preferably are contiguous with the inner surface 44 of shroud 20.

Disposed within housing 40 is a generator 45 that is connected by mounts 46 and 48 to the interior surface 44 of the housing 40. As axle 50 is rotated, it causes electricity to be generated in generator 45. The electricity so produced is delivered by conventional means (not shown) to a desired end use.

Referring again to FIG. 5, it will be seen that rotor 52 is mounted on axle 50. As air (not shown) passes over blades 22, it causes them to move in an axial direction and to cause the rotation of axle 50.

In the preferred embodiment depicted in FIG. 5, a cone diffuser 54 is mounted on rotor 52 aid in directing air past the blades 22.

In the preferred embodiment depicted in FIG. 5, a vorticity reducing cowling 56 is preferably disposed in front of stator 52 to reduce the rotor blade tip vorticity. As is known to those skilled in the art, vorticity, for fluid flow, is a vector equal to the curl of the velocity of flow. Reference may be had, e.g., to U.S. Pat. Nos. 4,145,921 (vorticity probe), 4,344,394 (piston engine using optimizable vorticity), 4,727,751 (crossflow vorticity sensor), 5,100,085 (airtip wingtip vorticity redistribution apparatus), 5,222,455 (ship wake vorticity suppressor), 6,507,793 (method for measuring vorticity), 7,134,631 (vorticity cancellation at trailing edge for induced drag elimination), 7,241,113 (vorticity control in a gas turbine engine), and the like; the entire disclosure of each of these United States patents is hereby incorporated by reference into this specification.

Referring again to FIG. 5, the cowling 56 is adapted to reduce the vorticity of the gases flowing onto and past blades 22. One may use any comparable vorticity modifying apparatus in the assembly 18.

FIG. 9 illustrates how the rotor 52 is preferably disposed behind cowling 56. As will be apparent, the axle 50 of generator 45 is connected to axle receptacle 58.

In U.S. Pat. No. 6,655,907, the entire disclosure of which is hereby incorporated by reference into this specification, claim 1 discloses: “1. A fluid-driven power generator comprised of a turbine comprised of a multiplicity of vanes, wherein said turbine is within a housing assembly, and wherein said housing assembly is comprised of an exhaust chamber, means for directing a first fluid towards said vanes of said turbine, means for directing a second fluid through said housing assembly without contacting said turbine, means for combining said first fluid and said second fluid in said exhaust chamber, and means for creating a vacuum in said exhaust chamber, wherein:

(a) said means for directing fluid towards said tangential portions of said turbine comprises a first interior sidewall, and a second interior sidewall connected to said first sidewall, and (b) said means for directing fluid towards said tangential portions of said turbine is comprised of means for causing said fluid to flow around said turbine and, for at least about 120 degrees of said flow of said fluid around said turbine, for constricting said fluid and increasing its pressure.”

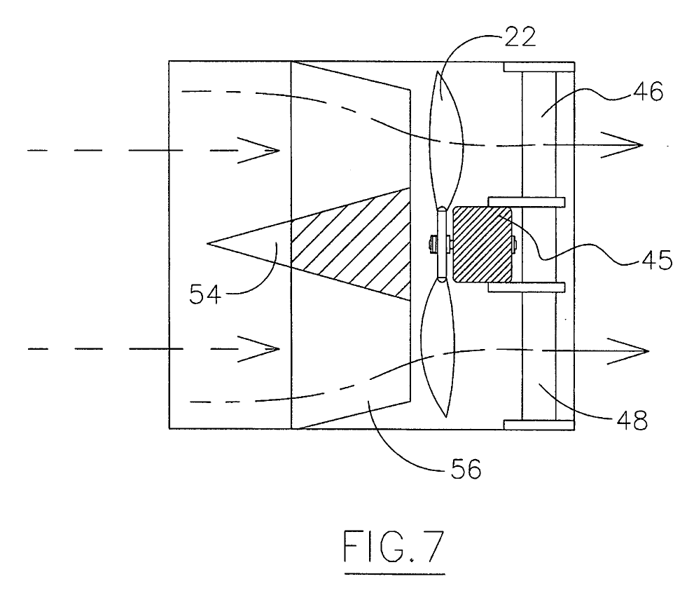

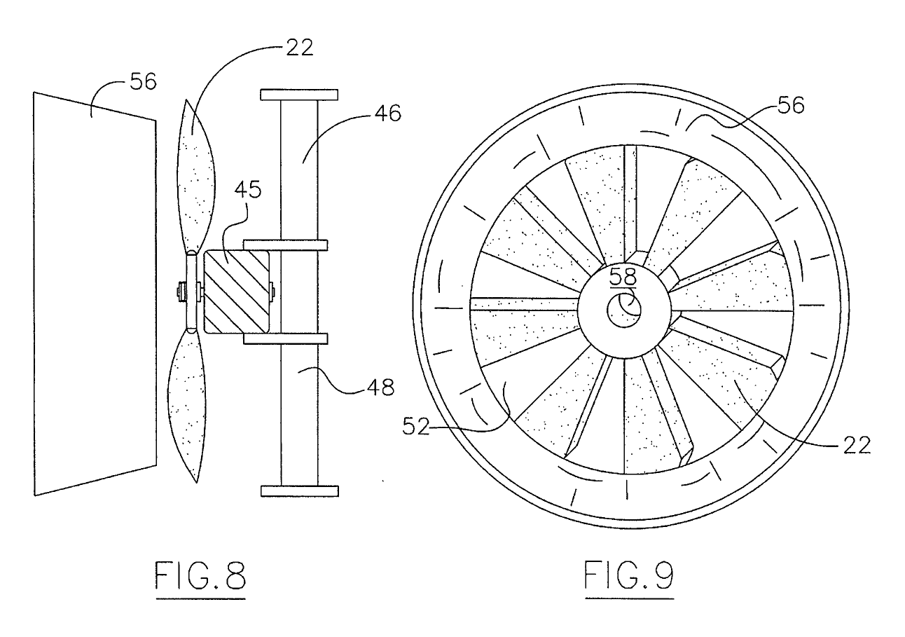

Referring to FIGS. 6 and 7, and in the preferred embodiment depicted therein, the device illustrated also creates a vacuum in an exhaust chamber.

Referring to FIG. 6, some of the wind flowing into the wind inlet suppressor 32 bypasses the interior 44 of shroud 20, while other of such wind flows through the interior of shroud 20. These two wind currents mix behind the rotor blades 22 in, e.g., chamber 60 of shroud 20. The two wind currents may also mix, e.g., within diffuser 24.

As will be apparent to those skilled in the art, by the particular combination of elements used in applicant's device, there is provided “ . . . means for directing a first fluid towards said vanes of said turbine, means for directing a second fluid through said housing assembly without contacting said turbine, means for combining said first fluid and said second fluid in said exhaust chamber, and means for creating a vacuum in said exhaust chamber . . . .”

U.S. Pat. No. 6,655,907 describes particular “ . . . means for directing a first fluid towards said vanes of said turbine, means for directing a second fluid through said housing assembly without contacting said turbine, means for combining said first fluid and said second fluid in said exhaust chamber, and means for creating a vacuum in said exhaust chamber . . . .” Any of these means may also be used in the apparatus 10 of the present invention.

Thus, e.g., one may use the structure described in claim 2 of such patent, which discloses “2. The power generator as recited in claim 1, wherein said means for creating a vacuum in said exhaust chamber is comprised of a movable vacuum flap disposed in said exhaust chamber.”

Thus, e.g., one may use the structure described in claim 3 of such patent, which discloses: “3. The power generator as recited in claim 2, wherein said housing is comprised of an air flow diverter.”

Thus, e.g., one may use the structure described in claim 4 of such patent, which discloses: “4. The power generator as recited in claim 3, wherein said vacuum flap is pivotally connected to said air flow diverter.”

Thus, e.g., one may use the structure described in claim 5 of such patent, which discloses: “5. The power generator as recited in claim 4, wherein said exhaust chamber is comprised of a constant area section and a varying area section.”

The entire disclosure of such U.S. Pat. No. 6,655,907 is hereby incorporated by reference into this specification.

I claim:

1. A diffuser augmented wind turbine assembly comprising an inlet wind suppressor and a shroud disposed within said inlet wind suppressor, wherein said assembly is comprised of a wind turbine, wherein said wind turbine is disposed within said shroud, and wherein said shroud is connected to a diffuser.

2. The diffuser augmented wind turbine assembly as recited in claim 2, wherein said wind turbine is comprised of a multiplicity of blades, and wherein said shroud is comprised of an exhaust chamber, and wherein said diffuser augmented wind turbine assembly is comprised of means for directing a first fluid towards said blades of said turbine, means for directing a second fluid through said shroud without contacting said turbine, means for combining said first fluid and said second fluid in said exhaust chamber, and means for creating a vacuum in said exhaust chamber.

3. The diffuser augmented wind turbine assembly as recited in claim 2, wherein said assembly further comprises a rotatable support connected to said diffuser augmented wind turbine assembly.

4. The diffuser augmented wind turbine assembly as recited in claim 2, wherein said wind turbine assembly is comprised of an axial flow wind turbine.

5. The diffuser augmented wind turbine assembly as recited in claim 4, wherein said diffuser has a maximum cross-sectional dimension that is greater than the maximum cross-sectional dimension of said shroud.

6. The diffuser augmented wind turbine assembly as recited in claim 5, wherein said inlet wind suppressor is comprised an interior surface and a multiplicity of vanes.

7. The diffuser augmented wind turbine assembly as recited in claim 6, wherein said vanes are integrally connected to said interior surface of said inlet wind suppressor.

8. The diffuser augmented wind turbine assembly as recited in claim 7, wherein said vanes are disposed axially equidistantly around said interior surface of said inlet wind suppressor.

9. The diffuser augmented wind turbine assembly as recited in claim 7, wherein said wind turbine assembly is comprised of a cone diffuser.

10. The diffuser augmented wind turbine assembly as recited in claim 9, wherein said cone diffuser is disposed in front of said blades.

11. The diffuser augmented wind turbine assembly as recited in claim 3, wherein said rotatable support is operatively connected to a yaw motor.

12. The diffuser augmented wind turbine assembly as recited in claim 2, wherein said wind turbine assembly is mounted on a tower.

13. The diffuser augmented wind turbine assembly as recited in claim 2, wherein said blades are connected to a rotor.

14. The diffuser augmented wind turbine assembly as recited in claim 10, wherein said diffuser augmented wind turbine assembly is comprised of a means for modifying the vorticity of the wind flowing into said assembly.
